(19) United States
(12) Patent Application Publication
(10) Pub. No.: US 2025/0149885 A1
(43) Pub. Date: May 8, 2025

(54) FAIL-SAFE AUTOMATIC MAINS-ELECTRICITY CUTOFF

(71) Applicant: ELECTRICAL SAFETY PRODUCTS, LLC, Ponchatoula, LA (US)

(72) Inventor: Timothy Franklin Phillips, Folsom, LA (US)

(73) Assignee: ELECTRICAL SAFETY PRODUCTS, LLC, Ponchatoula, LA (US)

(21) Appl. No.: 18/388,087

(22) Filed: Nov. 8, 2023

(51) Int. Cl. H02J 3/00; H02H 1/00; H02H 7/22; H02J 7/00; H02J 13/00

(52) U.S. Cl. CPC H02J 3/001; H02H 1/0007; H02H 7/22; H02J 7/0063; H02J 13/00022

(57) ABSTRACT

A fail-safe automatic mains-electricity cutoff system and method for automatic disconnection from a mains service drop in the event of mains power outage or instability, and automatic reconnection after restoration of stable mains power, with indications of operational status through a unit display, an indicator light, and an RF communication link to a remote unit. A unit enclosure having a unit door and a ground bus houses the fail-safe automatic mains-electricity cutoff system which is installed on the mains service drop, below the electrical meter and above the main breaker panel or main service disconnect switch. Low-voltage DC power for system operation is supplied through a battery unit. Disconnection and connection to mains power is effected through a switching unit providing a mains-voltage sensor, a fail-safe switch and a fail-safe switch actuator. A premises-voltage sensor and current sensor can also be provided in embodiments. A controller controls operation of the fail-safe automatic mains-electricity cutoff system based on real-time measurements and programmed operational parameters, and records and reports system status and measurements.

### BACKGROUND OF THE INVENTION

This invention provides a fail-safe automatic mains-electricity cutoff system and method for automatic disconnection from a mains service drop in the event of mains power outage or instability, and automatic reconnection after restoration of stable mains power.

In North America, electric power for residential and light commercial premises is typically supplied through a mains service drop as 120/240 Volt AC split-phase power, where the premises might use 240-volt dedicated circuits for a few appliances, and 120-volt circuits for everything else. An electricity supply system and electric power distribution system supplies higher-voltage power to a distribution transformer which lowers voltage to the utilization voltages of 240 Volts between two current-carrying conductors, and 120 Volts between a single current-carrying conductor and a center-tapped neutral conductor.

The electric power distribution system, sometimes called “the grid,” can be damaged or compromised by catastrophic events such as storms, fires, floods, and earthquakes, or by structural or operational failure of critical power generation, transmission, and switching facilities. Excessive demand can also compromise the availability of stable electric power at the mains service drop. Damage to overhead power lines is common, and usually affects a large number of power lines in an area. Damage to the electric power distribution system will usually cause a power outage affecting multiple mains service drops. Repair of the damaged equipment usually requires multiple instances of repair at multiple sites, under power-outage conditions and often other challenging conditions. For safety reasons and for other reasons the repairs have to be made on power lines and equipment which are not energized with electricity. Even the possibility that equipment under repair can become energized by backfeeding through one or more mains service drops presents a very serious danger to persons attempting to make repairs. Beyond the significant danger to repair crews, backfeeding electricity can also interfere with repair by, for example, tripping a network protector device.

During a power outage lasting days or weeks, a large number of residential and light commercial premises will utilize an emergency power source. If an alternative power source such as solar panels or an emergency power source such as a permanently mounted emergency generator has already been installed prior to the power outage, then under the applicable regulations and codes a proper transfer switch will have also been installed. The installation is done by a licensed electrician and is subject to inspection, so there is substantially no danger of backfeeding occurring from such a system.

Portable emergency electric generators are available and are becoming increasingly more available. Such emergency generators usually use gasoline or bottled gas, which present additional problems. Improvements in battery performance and availability, and improvements in electrical inverter technology, make high-wattage battery-powered emergency generators possible. Although all of the emergency generators come with clear warnings against the use of “suicide cords” to connect the emergency generator to the premises wiring, consequently backfeeding through the main service drop, there is no control over who can purchase an emergency generator or who can borrow or otherwise obtain an emergency generator. Because the emergency generators are used under emergency power-outage conditions, with the power companies and law enforcement otherwise occupied, there cannot be any meaningful inspections of or restrictions on the use of emergency generators. Therefore, a significant risk of backfeeding exists in any power outage which lasts long enough for people to deploy emergency generators.

After a power outage, during the re-powering of a mains service drop or group of service drops, the power might come on and immediately trip off, or might come on at an under-voltage brownout or over-voltage surge, or might otherwise be very unstable. One of the significant reasons for such initial instability of restored power is the very large loads, including capacitative and inductive loads, encountered when every light, appliance, and HVAC system on the service drop is energized at once, multiplied by the number of service drops simultaneously re-powered. The unstable power conditions experienced during re-powering can be damaging both to the electric provider and to the customer.

What is needed is a fail-safe automatic mains-electricity cutoff system and method which automatically disconnects and isolates from the mains service drop in the event of mains power outage or instability, and which automatically reconnects after restoration and stabilization of mains power.

### SUMMARY OF THE INVENTION

This invention provides a fail-safe automatic mains-electricity cutoff system and method for automatic disconnection from a mains service drop in the event of mains power outage or instability, and automatic reconnection after restoration of stable mains power.

The fail-safe automatic mains-electricity cutoff system provides indications of operational status through a unit display, an indicator light, and an RF communication link to a remote unit. A unit enclosure having a unit door and a ground bus houses the system. The fail-safe automatic mains-electricity cutoff system is installed on the mains service drop, below the electrical meter and above the main breaker panel or main service disconnect switch. Low-voltage DC power for system operation is supplied through a battery unit. Disconnection and connection to mains power is effected through a switching unit providing a mains-voltage sensor, a fail-safe switch and a fail-safe switch actuator. A premises-voltage sensor and current sensor can also be provided in embodiments. A controller controls operation of the fail-safe automatic mains-electricity cutoff system based on real-time measurements and programmed operational parameters, and records and reports system status and measurements.

### BRIEF DESCRIPTION OF THE DRAWINGS

Reference will now be made to the drawings, wherein like parts are designated by like numerals, and wherein:

FIG. 1 is a schematic view of the fail-safe automatic mains-electricity cutoff system of the invention in use between a meter and a main breaker panel;

FIG. 2 is a schematic view of the fail-safe automatic mains-electricity cutoff system of the invention in use between a meter and a main disconnect switch;

FIG. 3 is a perspective view of the fail-safe automatic mains-electricity cutoff system of the invention in use with the unit door closed;

FIG. 4 is a perspective view of the fail-safe automatic mains-electricity cutoff system of the invention in use with the unit door open;

FIG. 5 is a perspective view of the fail-safe automatic mains-electricity cutoff system of the invention showing hidden elements, in use, in a closed-connected position; and

FIG. 6 is a perspective view of the fail-safe automatic mains-electricity cutoff system of the invention showing hidden elements, in use, in an open-disconnected position.

### DETAILED DESCRIPTION OF THE INVENTION

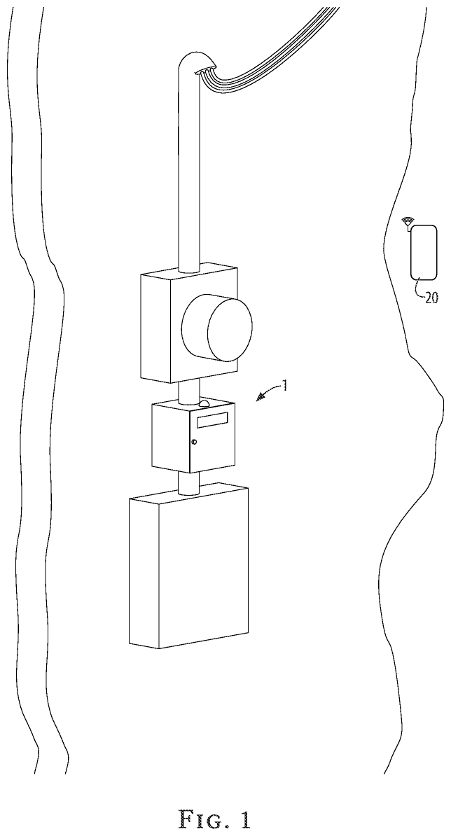

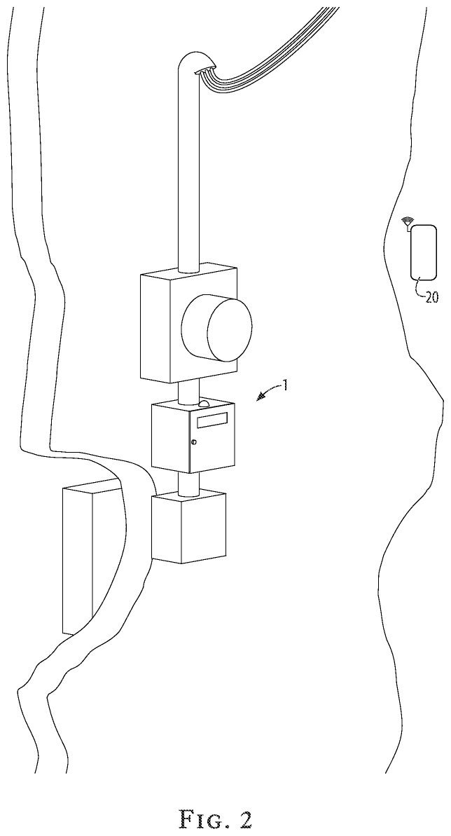

Referring to FIG. 1, the fail-safe automatic mains-electricity cutoff system 1 is shown in use installed between the electric meter and the main breaker panel of a typical residential or light commercial premises in North America. Referring additionally to FIG. 2, the fail-safe automatic mains-electricity cutoff system 1 is shown in use between the electric meter and a main service disconnect switch, where the main breaker panel is installed elsewhere. The fail-safe automatic mains-electricity cutoff system 1 provides for real-time monitoring of the presence and quality of the AC voltage supplied by the electric utility provider's mains service drop, and provides for the automatic disconnecting and reconnecting of that service drop to the premises electrical system, thereby providing either isolation from or connection to the utility's mains service drop, automatically, based primarily upon the presence or absence, and the quality of the AC voltage, with recording and reporting of operating status, as treated in detail herein.

The fail-safe automatic mains-electricity cutoff system 1 provides for monitoring, reporting, and alerting of status, and optionally for directing operations, through a remote unit 20, as treated in detail below.

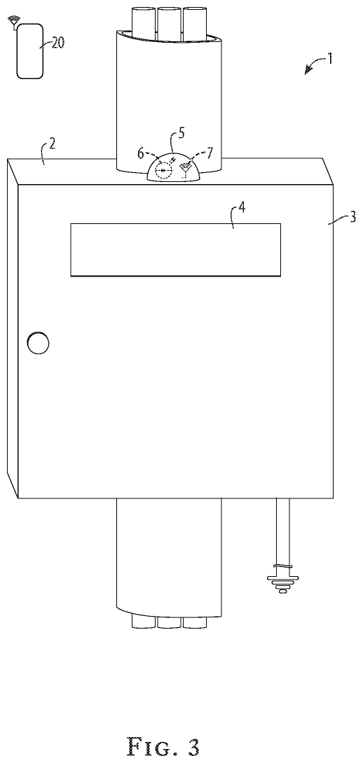

Referring to FIG. 3, the fail-safe automatic mains-electricity cutoff system 1 provides a unit enclosure 2 having a unit door 3. Subject to specific local requirements the unit enclosure 2 and unit door 3 can be made of metal or of a plastic, with metal being the preferred and possibly required material. A metal unit enclosure 2 and unit door 3 when grounded will block light and electromagnetic energy from entering or exiting the enclosure. A unit display 4 is provided, mounted on the outside of the unit door 3. The unit display 4 shows information about the operation of the fail-safe automatic mains-electricity cutoff system 1. A non-blocking cover 5 is provided, providing an area that light and radio-frequency (RF) can pass through. In the illustrated embodiment the non-blocking cover 5 is implemented as a dome of transparent or translucent plastic, such as an acrylic or polycarbonate plastic, mounted on the top of the unit enclosure to avoid blocking of visibility and RF transmission. The non-blocking cover 5 can also be implemented as a plastic-covered hole or window cut into the unit enclosure 2 or unit door 3. An indicator light 6 is mounted within the non-blocking cover 5, to provide an easily seen and easily understood indication of the operating status of the system, as treated below. The indicator light 6 can be one or more light-emitting diodes (LEDs) including multicolor LEDs having more than one LED inside a single unit. Providing different colors allows for indication of more detailed status information. An RF communication link 7 is also mounted within the non-blocking cover 5, to provide for communications, including communications with the remote unit 20, as treated below. The RF communication link 7 can be implemented as a small RF antenna operating at a publicly useable frequency, such as 2.4 GHz in the US. With proper licensing the RF communication link 7 can use wireless network protocols and standards such as the WI-FI or BLUETOOTH standards or can use the network of a cellular telephone provider.

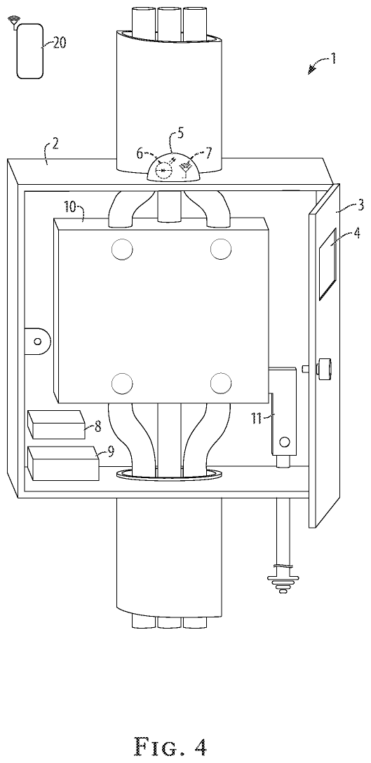

Referring to FIG. 4, a typical installation on a split-phase 240-120 Volt AC mains service drop is illustrated. When installed and in use, the current-carrying conductors of the mains service drop coming out of the electric meter are routed through the top of the unit enclosure 2 and are connected to a switching unit 10, which is treated in detail below. Conductors of the same size and type are connected to the switching unit 10 and are routed through the bottom of the unit enclosure 2, typically either to a main breaker panel or to a main disconnect switch ahead of the breaker panel. Where a neutral conductor is provided in the mains service drop the neutral conductor connection is passed through the unit enclosure 2 and switching unit 10. A ground bus 11 within the unit enclosure 2 provides for bonding the enclosure and its components to each other and to earth ground, for safety purposes.

The fail-safe automatic mains-electricity cutoff system 1 provides a controller 8 which controls the operations of the system, as treated in detail below. The controller 8 can be implemented on a microprocessor-based small computing device, including available standard devices such as microcontrollers, systems on a board, and systems on a chip. Low-voltage DC power for operation of the controller 8 is provided by a battery unit 9. In a preferred embodiment the battery unit 9 draws a small amount of high AC Voltage from the mains service drop and converts that power to a lower DC Voltage at a controlled lower DC current for the purpose of providing low-voltage DC power for operations while the mains service drop is energized, and for the purpose of maintaining the charge of a battery which provides power for operations when the mains service drop is not energized during a power outage. The power conversion and battery-charge maintenance functions can be implemented in the controller 8, the battery unit 9, or in both. Optionally, the battery unit 9 can be designed to scavenge any voltage present on the premises side, or to be recharged through a provided connector such as a standard USB charging device.

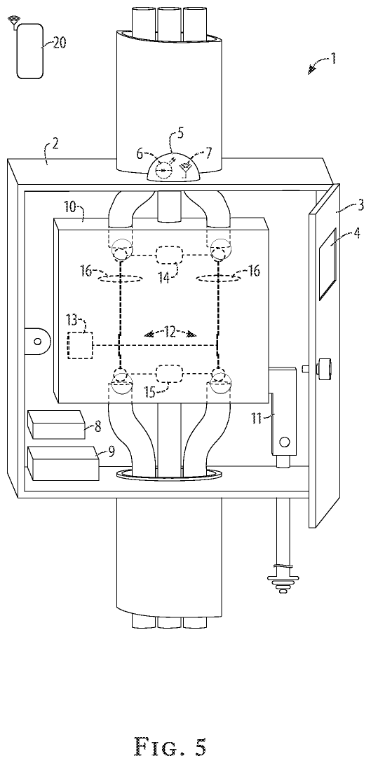

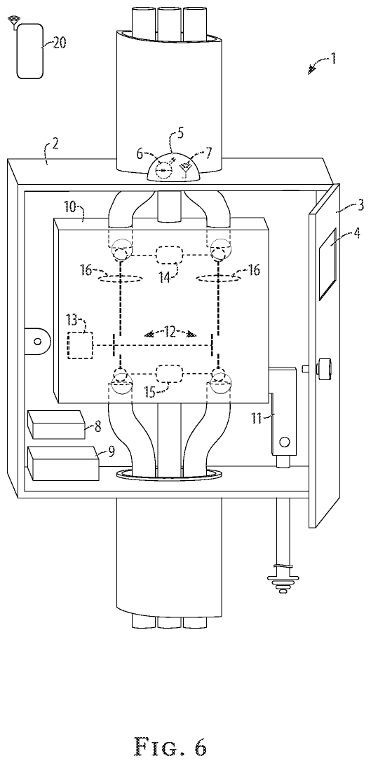

Referring to FIG. 5 and FIG. 6, the switching unit 10 provides conductive paths for each of the current-carrying conductors which can switch between a closed-connected state and an open-disconnected state, under the control of the controller 8. The switched connections are made and broken by a fail-safe switch 12 actuated by a fail-safe switch actuator 13. The fail-safe switch 12 and fail-safe switch actuator 13 are designed to avoid failure, but to open-disconnect the connections in the event of failure. The switch can be designed, for example, to be withdrawn by a spring into the open-disconnected position in the absence of being pushed into the closed-connected position by an electromechanical actuator.

A mains-voltage sensor 14 senses the presence and quality of voltage on the current-carrying conductors. In the illustrated and typical split-phase 240-120 Volt AC mains service drop the voltage expected to be present is 240 Volts AC RMS. It is not necessary to consider the voltage with reference to the neutral conductor for this type of service drop. Determination of the presence of a proper voltage is made by measuring the voltage in real time to determine whether the measured voltage equals the nominal voltage expected to be provided by the mains service drop or is near the nominal voltage within a defined usually narrow range which will allow for small and transitory under-voltages and over-voltages. The quality of the voltage is an indication of the stability of the voltage, in consideration of the damaging effects unstable voltage can have on electrical devices, appliances, and systems. Determination of the quality of voltage sensed by the mains-voltage sensor 14 on the current-carrying conductors is made by analyzing the real-time voltage measurements over one or more rolling periods of time, usually seconds or minutes up to perhaps an hour, and determining, for example, whether the voltage has intermittently failed or has diminished to a brownout level or risen to a surge level, which are conditions which might be encountered prior to a total power outage, and encountered again during the period when power is being restored. Different residential or light commercial premises might have different capabilities for withstanding under-voltages and over-voltages, such as having voltage-conditioning devices either for the whole premises or for vulnerable appliances or equipment. Therefore, different premises might be able to tolerate a larger or smaller degradation of quality, or shorter or longer periods of degradation of quality, and the controller 8 can be programmed to tolerate more or less degradation of quality as appropriate. The quality of the voltage on the mains service drop might fluctuate immediately before a complete power outage, and different premises will have different considerations for whether mains power should be disconnected sooner upon sensing a drop in quality or later upon a complete outage. When mains power is restored in an area following emergency repairs the mains service drop for a particular premises might initially only provide intermittent bumps of power or might provide power of fluctuating quality. In circumstances where the mains power is already disconnected due to a power outage, the controller 8 can be programmed to briefly delay re-connecting to mains power until the quality of the mains power has stabilized.

The controller 8 controls the basic operations of the fail-safe automatic mains-electricity cutoff system 1 by sensing through the mains-voltage sensor 14 the presence of voltage on the mains service drop, analyzing the quality of that voltage, and operating the fail-safe switch 12 and fail-safe switch actuator 13 to connect or disconnect from mains power, as treated above. The controller 8 also causes information to be displayed upon the unit display 4, operates the indicator light 6, and sends information through the RF communication link 7 to the remote unit 20. Additionally, in a preferred embodiment, the controller 8 also makes a record of the system status over time, and can analyze and generate reports on system operations, including detailed documentation of power outages and degradation of power quality such as under-voltages, over-voltages, and unstable voltages. Such records and reports can be accessed through the RF communications link 7.

In an embodiment providing additional protections against backfeeding, a premises-voltage sensor 15 is further provided, which monitors the voltage at the premises side of the fail-safe switch 12. When the fail-safe switch is open-disconnected, if the controller 8 senses a voltage on the premises side of the open switch, the controller 8 can prevent the reconnection to mains power, and can display alerts about the condition through the unit display 4, indicator light 6, and RF communication link 7.

In an optional current-monitoring embodiment a current sensor 16 is additionally provided which measures in the electrical current or amperage flowing through the switching unit 10, and communicates the real-time measurements to the controller 8. The controller 8 can use the amperage measurements in analyzing the quality of the mains power. The controller 8 can also use the amperage measurements to identify problems or potential problems such as poor balance between the two legs of the split-phase system. The controller 8 can also record and report on the usage of electric current over time.

Many other changes and modifications can be made in the system and method of the present invention without departing from the spirit thereof. I therefore pray that my rights to the present invention be limited only by the scope of the appended claims.

I claim:

1. A fail-safe automatic mains-electricity cutoff system comprising:
(i) a unit enclosure having a unit door;
(ii) a ground bus mounted within said unit enclosure, adapted to provide a connection to earth ground;
(iii) a controller mounted within said unit enclosure, adapted to control, record, and report system operations;
(iv) a unit display mounted on said unit door, adapted to display information about system operations under control of said controller;
(v) a non-blocking cover mounted on said unit enclosure;
(vi) an indicator light mounted within said unit enclosure behind said non-blocking cover, adapted to provide a visual indication of system status under control of said controller;
(vii) an RF communication link mounted within said unit enclosure behind said non-blocking cover, adapted to communicate with a remote unit, under control of said controller;
(viii) a battery unit adapted to provide power for operation of said controller, said switching unit, said indicator light, and said RF communication link;
(ix) a switching unit mounted within said unit enclosure, adapted to switch a connection between the mains service drop and the premises electrical system between a closed-connected state and an open-disconnected state, and sensing in real time the state of the switched connection and the presence and quality of voltage on the mains service drop, under control of said controller;
(x) a mains-voltage sensor within said switching unit, adapted to sense the presence and quality of voltage on the mains service drop, and to supply such information to said controller;
(xi) a fail-safe switch and a fail-safe switch actuator within said switching unit, adapted to make and break the connection between the mains service drop and the premises electrical system, under control of said controller, and to fail in an open-disconnected state; and
(xii) a remote unit adapted to receive operational status information through said RF communication link, under control of said controller.

2. The fail-safe automatic mains-electricity cutoff system of claim 1, where said controller is further adapted to control system operations by sensing in real time the presence of voltage on the mains service drop through said mains-voltage sensor, and by causing the switched connection between the mains service drop and the premises electrical system to become open-disconnected through said fail-safe switch and said fail-safe switch actuator when the voltage on the mains service drop is absent.

3. The fail-safe automatic mains-electricity cutoff system of claim 1, where said controller is further adapted to control system operations by sensing in real time the quality of voltage on the mains service drop through said mains-voltage sensor, and by causing the switched connection between the mains service drop and the premises electrical system to become open-disconnected through said fail-safe switch and said fail-safe switch actuator when the voltage on the mains service drop is not of sufficient quality.

4. The fail-safe automatic mains-electricity cutoff system of claim 1, where said controller is further adapted to control system operations by sensing in real time the quality of voltage on the mains service drop through said mains-voltage sensor, and by causing the switched connection between the mains service drop and the premises electrical system to become closed-connected through said fail-safe switch and said fail-safe switch actuator when the voltage on the mains service drop is of sufficient quality.

5. The fail-safe automatic mains-electricity cutoff system of claim 1, further comprising a premises-voltage sensor within said switching unit, adapted to sense the presence and quality of voltage on the premises electrical system, and to transmit such information to said controller.

6. The fail-safe automatic mains-electricity cutoff system of claim 1, further comprising a premises-voltage sensor within said switching unit, adapted to sense the presence and quality of voltage on the premises electrical system, and to transmit such information to said controller, and where said controller is further adapted to control system operations by sensing in real time the presence and quality of voltage on the mains service drop through said mains-voltage sensor, by sensing in real time the presence of voltage on the premises electrical system, by causing the switched connection between the mains service drop and the premises electrical system to become closed-connected through said fail-safe switch and said fail-safe switch actuator when the voltage on the mains service drop is of sufficient quality and when no voltage is present on the premises electrical system.

7. The fail-safe automatic mains-electricity cutoff system of claim 1, where said controller is further adapted to record and report operational status through said RF communications link and said remote unit.

8. The fail-safe automatic mains-electricity cutoff system of claim 1, further comprising a current sensor within said switching unit, adapted to sense electrical current flowing through said switching unit, and to transmit such information to said controller.

9. The fail-safe automatic mains-electricity cutoff system of claim 1, further comprising a current sensor within said switching unit, adapted to sense electrical current flowing through said switching unit, and to transmit such information to said controller, and where said controller is further adapted to record and report electrical-current information.

10. The fail-safe automatic mains-electricity cutoff system of claim 1, where said remote unit is further adapted to provide remote control of operations.

11. The fail-safe automatic mains-electricity cutoff system of claim 1, where said remote unit further comprises implementation on a computer device.

12. The fail-safe automatic mains-electricity cutoff system of claim 1, where said remote unit further comprises implementation on a portable computer device.

13. The fail-safe automatic mains-electricity cutoff system of claim 1, where said remote unit further comprises implementation on a smartphone device.

14. The fail-safe automatic mains-electricity cutoff system of claim 1, where said battery unit is further adapted to use voltage present on the premises electrical system when no voltage is present on the mains service drop.

15. The fail-safe automatic mains-electricity cutoff system of claim 1, where said battery unit is further adapted to use voltage supplied by an external source.

16. The fail-safe automatic mains-electricity cutoff system of claim 1, where said battery unit is further adapted to use voltage supplied through a USB connection.

17. A fail-safe automatic mains-electricity cutoff method comprising:
(i) providing a fail-safe automatic mains-electricity cutoff system, comprising:
(a) a unit enclosure having a unit door;
(b) a ground bus mounted within said unit enclosure, adapted to provide a connection to earth ground;
(c) a controller mounted within said unit enclosure, adapted to control, record, and report system operations;
(d) a unit display mounted on said unit door, adapted to display information about system operations under control of said controller;
(e) a non-blocking cover mounted on said unit enclosure;
(f) an indicator light mounted within said unit enclosure behind said non-blocking cover, adapted to provide a visual indication of system status under control of said controller;
(g) an RF communication link mounted within said unit enclosure behind said non-blocking cover, adapted to communicate with a remote unit, under control of said controller;
(h) a battery unit adapted to provide power for operation of said controller, said switching unit, said indicator light, and said RF communication link;
(i) a switching unit mounted within said unit enclosure, adapted to switch a connection between the mains service drop and the premises electrical system between a closed-connected state and an open-disconnected state, and sensing in real time the state of the switched connection and the presence and quality of voltage on the mains service drop, under control of said controller;
(j) a mains-voltage sensor within said switching unit, adapted to sense the presence and quality of voltage on the mains service drop, and to supply such information to said controller;
(k) a fail-safe switch and a fail-safe switch actuator within said switching unit, adapted to make and break the connection between the mains service drop and the premises electrical system, under control of said controller, and to fail in an open-disconnected state; and
(l) a remote unit adapted to receive operational status information through said RF communication link, under control of said controller; and
(ii) installing said fail-safe automatic mains-electricity cutoff system on the mains service drop;
where, in operation, said controller controls system operations by sensing in real time the presence of voltage on the mains service drop through said mains-voltage sensor, by causing the switched connection between the mains service drop and the premises electrical system to become open-disconnected through said fail-safe switch and said fail-safe switch actuator when the voltage on the mains service drop is not of sufficient quality, and by causing the switched connection between the mains service drop and the premises electrical system to become closed-connected through said fail-safe switch and said fail-safe switch actuator when the voltage on the mains service drop is of sufficient quality.

18. A fail-safe automatic mains-electricity cutoff system comprising:
(i) a unit enclosure having a unit door;
(ii) a ground bus mounted within said unit enclosure, adapted to provide a connection to earth ground;
(iii) a controller mounted within said unit enclosure, adapted to record and report system operations, and adapted to control system operations by sensing in real time the quality of voltage on the mains service drop, and by causing a switched connection between the mains service drop and the premises electrical system to become open-disconnected when the voltage on the mains service drop is not of sufficient quality, and by causing the switched connection between the mains service drop and the premises electrical system to become closed-connected when the voltage on the mains service drop is of sufficient quality;
(iv) a unit display mounted on said unit door, adapted to display information about system operations under control of said controller;
(v) a non-blocking cover mounted on said unit enclosure;
(vi) an indicator light mounted within said unit enclosure behind said non-blocking cover, adapted to provide a visual indication of system status under control of said controller;
(vii) an RF communication link mounted within said unit enclosure behind said non-blocking cover, adapted to communicate with a remote unit, under control of said controller;
(viii) a battery unit adapted to provide power for operation of said controller, said switching unit, said indicator light, and said RF communication link;
(ix) a switching unit mounted within said unit enclosure, adapted to switch a connection between the mains service drop and the premises electrical system between a closed-connected state and an open-disconnected state, and sensing in real time the state of the switched connection and the presence and quality of voltage on the mains service drop, under control of said controller;
(x) a mains-voltage sensor within said switching unit, adapted to sense the presence and quality of voltage on the mains service drop, and to supply such information to said controller;
(xi) a fail-safe switch and a fail-safe switch actuator within said switching unit, adapted to make and break the connection between the mains service drop and the premises electrical system, under control of said controller, and to fail in an open-disconnected state;
(xii) a remote unit adapted to receive operational status information and to control system operation, through said RF communication link under control of said controller.
